(19) United States
(12) Patent Application Publication
(10) Pub. No.: US 2020/0319488 A1
(43) Pub. Date: Oct. 8, 2020

(54) DISPLAY DEVICE

(71) Applicant: Japan Display Inc., Minato-ku (JP)

(72) Inventors: Genki ASOZU, Tokyo (JP); Toshiyuki HIGANO, Tokyo (JP)

(73) Assignee: Japan Display Inc., Minato-ku (JP)

(21) Appl. No.: 16/907,971

(22) Filed: Jun. 22, 2020

Related U.S. Application Data
(63) Continuation of application No. PCT/JP2018/040339, filed on Oct. 30, 2018.

(30) Foreign Application Priority Data
Dec. 22, 2017 (JP) 2017-246643

(51) Int. Cl. G02F 1/1339; G09F 9/30; G02F 1/13357

(52) U.S. Cl. CPC G02F 1/1339; G02F 1/1336; G09F 9/301

(57) ABSTRACT

According to one embodiment, a display device includes a display panel including a flat portion and a bend portion adjacent to the flat portion. The display panel includes a first substrate, a second substrate, and a sealant bonding the first substrate and the second substrate together. The sealant is filled in the bend portion.

### CROSS-REFERENCE TO RELATED APPLICATIONS

This application is a Continuation Application of PCT Application No. PCT/JP2018/040339, filed Oct. 30, 2018 and based upon and claiming the benefit of priority from Japanese Patent Application No. 2017-246643, filed Dec. 22, 2017, the entire contents of all of which are incorporated herein by reference.

### FIELD

Embodiments described herein relate generally to a display device.

### BACKGROUND

Recently, various optical elements using pairs of substrates having flexibility have been proposed. For example, with regard to the elastic modulus of a sealant bonding the pair of substrates at room temperature after the sealant is hardened, it is known that the sealant disposed along a side to be bent has a lower elastic modulus than the sealant disposed along a side not to be bent.

### BRIEF DESCRIPTION OF THE DRAWINGS

FIG. 1 is a plan view showing the configuration of a display device DSP of the present embodiment.

FIG. 2 is a cross-sectional view of the display device DSP taken along line A-B of FIG. 1.

FIG. 3 is an illustration for explaining a state where the display device DSP is bent along bend lines BL1 and BL2.

FIG. 4 is an illustration for explaining a state where the display device DSP is bent along bend lines BL3 and BL4.

FIG. 5 is a cross-sectional view showing the display device DSP bent along the bend line BL1.

FIGS. 6A and 6B are schematic cross-sectional views explaining a width WOL over which a second optical film OF2 overlaps with respect to a width WRM over which a first optical film OF1 is removed.

FIG. 7 is a cross-sectional view showing the display device DSP bent along the bend lines BL3 and BL4.

FIG. 8 is a plan view showing a configuration example of a sealant stopper portion SS.

FIG. 9 is a plan view for explaining the positional relationship between a first substrate SUB1 and a sealant SL.

FIGS. 10A to 10C are cross-sectional views showing the first configuration example of the sealant stopper portion SS.

FIGS. 11A to 11C are cross-sectional views showing the second configuration example of the sealant stopper portion SS.

FIGS. 12A to 12C are cross-sectional views showing the third configuration example of the sealant stopper portion SS.

FIG. 13 is an illustration showing the configuration of the display device DSP.

FIG. 14 is a cross-sectional view showing a configuration example of a pixel PX.

FIG. 15 is an illustration showing a specific example of convex portions CV11 and CV21.

FIG. 16 is an illustration showing a specific example of concave portions CC11 and CC21.

### DETAILED DESCRIPTION

In general, according to one embodiment, there is provided a display device including a display panel including a flat portion and a bend portion adjacent to the flat portion. The display panel includes a first substrate, a second substrate, and a sealant which bonds the first substrate and the second substrate together. The sealant is filled in the bend portion.

Embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, and the like of the respective parts are illustrated schematically in the drawings, rather than as an accurate representation of what is implemented, but such schematic illustration is merely exemplary, and in no way restricts the interpretation of the invention. In addition, in the specification and drawings, constituent elements which function in the same or a similar manner to those described in connection with preceding drawings are denoted by the same reference numbers, and detailed explanations of them that are considered redundant may be arbitrarily omitted.

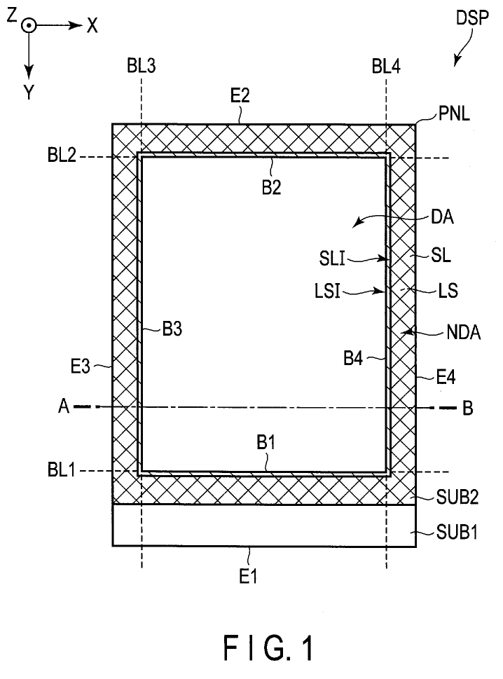

FIG. 1 is a plan view showing the configuration of a display device DSP of the present embodiment. Note that a first direction X, a second direction Y and a third direction Z shown in the drawing are orthogonal to one another but may cross at an angle other than 90 degrees. The first direction X and the second direction Y correspond to directions parallel to the main surface of a substrate constituting the display device DSP, and the third direction Z corresponds to the thickness direction of the display device DSP. In the following description, a direction toward the pointing end of an arrow indicating the third direction Z will be referred to as “above” and a direction away from the pointing end of the arrow will be referred to as “below”. When described as “the second member above the first member” and “the second member below the first member”, the second member may be in contact with the first member or may be separated from the first member. In addition, viewing an X-Y plane defined by the first direction X and the second direction Y from the pointing end side of the arrow indicating the third direction Z will be referred to as planar view.

The display device DSP includes a display panel PNL. The display panel PNL is, for example, a liquid crystal panel and includes a first substrate SUB1, a second substrate SUB2 and a liquid crystal layer (a liquid crystal layer LC which will be described later). The first substrate SUB1 and the second substrate SUB2 are opposed to each other in the third direction Z and are bonded together by a sealant SL.

The display device DSP includes a display area DA in which an image is displayed and a non-display area NDA which is located around the display area DA. The non-display area NDA is formed in the shape of a frame. The sealant SL is located in the non-display area NDA. The display area DA is surrounded by a light-shielding layer LS disposed in the second substrate SUB2. The sealant SL overlaps the light-shielding layer LS in planar view. In FIG. 1, the sealant SL is indicated by diagonal lines slanting upward to the right, and the light-shielding layer LS is indicated by diagonal lines slanting downward to the right.

The display device DSP has sides E1 and E2 extending along the first direction X and sides E3 and E4 extending along the second direction Y. The first substrate SUB1 and the second substrate SUB2 are formed of a material having flexibility. Therefore, the display device DSP can be bent along bend lines BL1 and BL2 along the first direction X. Alternatively, the display device DSP can be bent along bend lines BL3 and BL4 along the second direction Y.

The bend lines BL1 to BL4 are located between the display area DA and the sides E1 to E4, respectively. The bend lines BL1 to BL4 linearly extend. In the illustrated example, the bend lines BL1 to BL4 are located at boundaries B1 to B4 between the display area DA and the non-display area NDA, respectively. The boundaries B1 and B2 correspond to linear portions along the first direction X, and the boundaries B3 and B4 correspond to linear portions along the second direction Y.

Inner edges LSI of the light-shielding layer LS match the boundaries B1 to B4. Inner edges SLI of the sealant SL are located more outward (farther from the display area DA) than the boundaries B1 to B4. Note that the inner edges SLI may match the boundaries B1 to B4. The positional relationship between the boundaries B1 to B4 and the bend lines BL1 to BL4 includes not only a case where they are located on the same straight lines but also a case where the bend lines BL1 to BL4 are located more outward than the boundaries B1 to B4. Note that the inner edges SLI of the sealant SL preferably match the bend lines BL1 to BL4, but due to an error occurring at the time of formation (application) of the sealant SL, the inner edges SLI may be located more inward than the bend lines BL1 to BL4 in some cases and may be located more outward than the bend lines BL1 to BL4 in other cases.

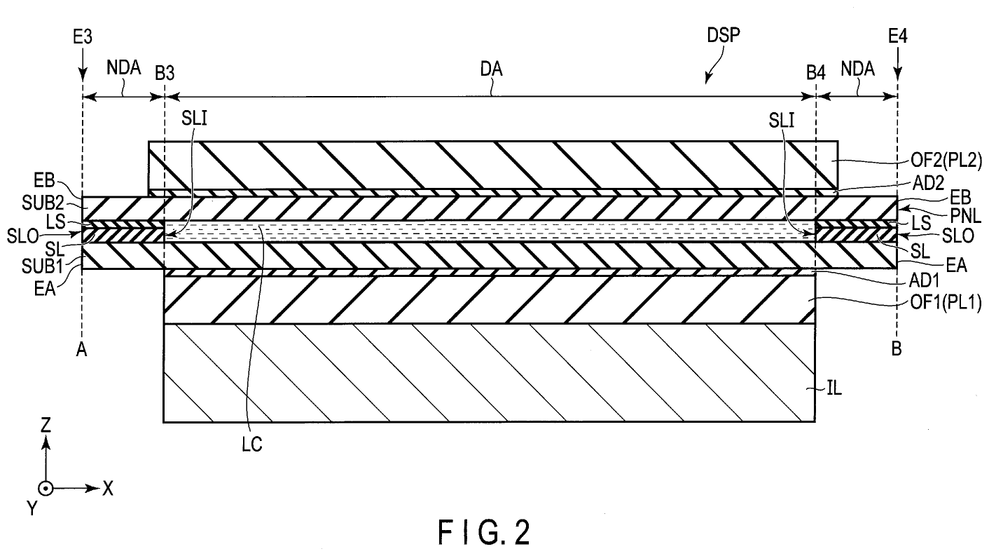

FIG. 2 is a cross-sectional view of the display device DSP taken along line A-B of FIG. 1. In addition to the display panel PNL shown in FIG. 1, the display device DSP also includes a first optical film OF1, a second optical film OF2, an adhesive layer AD1 interposed between the display panel PNL and the first optical film OF1, an adhesive layer AD2 interposed between the display panel PNL and the second optical film OF2, and an illumination device IL.

The first optical film OF1 includes a first polarizing layer PL1 and is bonded to the first substrate SUB1 by the adhesive layer AD1. The second optical film OF2 includes a second polarizing layer PL2 and is bonded to the second substrate SUB2 by the adhesive layer AD2. The first optical film OF1 is disposed at least in the display area DA. The second optical film OF2 extends more outward than the first optical film OF1 and is disposed not only in the display area DA but also in the non-display area NDA. The first optical film OF1 and the second optical film OF2 have a basic structure in which a polarizing layer is held between a pair of support bodies, but may include another optical function layer such as a retardation layer.

In the cross-section in the drawing, the light-shielding layer LS is disposed between the side E3 and the boundary B3 and between the side E4 and the boundary B4. The inner edges SLI of the sealant SL are located closer to the boundaries B3 and B4 in the non-display area NDA. Outer edges SLO of the sealant SL are located at the sides E3 and E4. Note that, at each of the sides E3 and E4, a substrate edge EA of the first substrate SUB1 overlaps a substrate edge EB of the second substrate SUB2, and the outer edge SLO overlaps the substrate edge EA and the substrate edge EB. This cross-sectional structure also applies to the side E2.

The liquid crystal layer LC is held between the first substrate SUB1 and the second substrate SUB2 on the inner side of the sealant SL. In some cases, the liquid crystal layer LC may be interposed between the light-shielding layer LS and the first substrate SUB1 in the non-display area NDA.

The illumination device IL is located on the lower side of the first optical film OF1 and illuminates the display panel PNL. The illumination device IL is disposed at least in the display area DA and may also be disposed in the non-display area NDA. The illumination device IL may be bonded to the first optical film OF1.

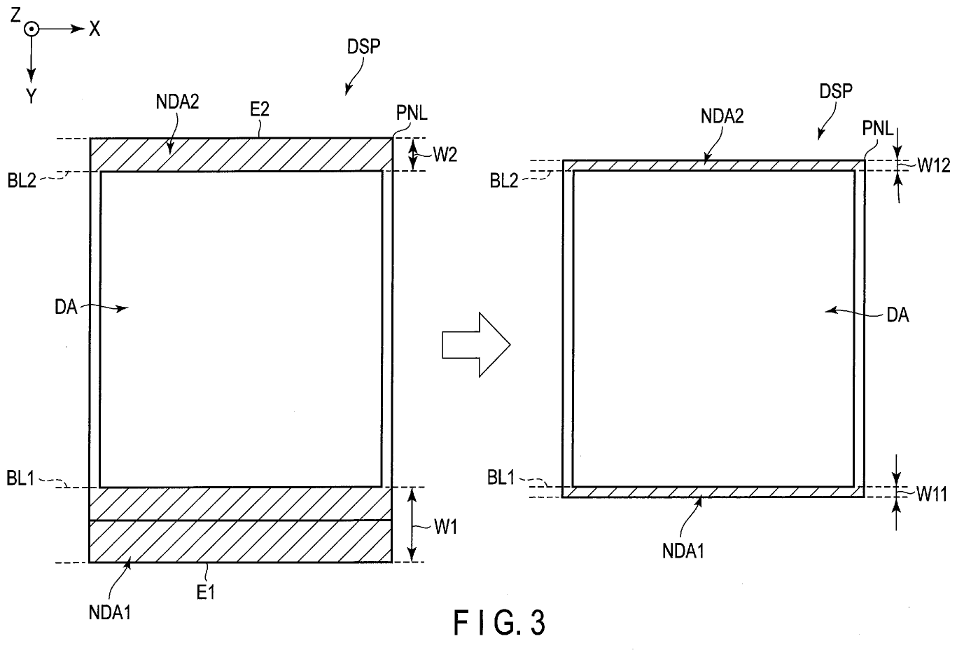

FIG. 3 is an illustration for explaining a state where the display device DSP is bent along the bend lines BL1 and BL2. A plan view on the left side of the drawing shows the display device DSP which is not bent yet. The display device DSP includes non-display areas NDA1 and NDA2 extending along the first direction X as the non-display area. The non-display area NDA1 is located between the side E1 and the display area DA and has a frame width W1 along the second direction Y. The non-display area NDA2 is located between the side E2 and the display area DA and has a frame width W2 along the second direction Y.

A plan view on the right side of the drawing shows the display area DSP which is bent along the bend lines BL1 and BL2. The illustrated display device DSP is bent such that the sides E1 and E2 shown in the plan view on the left side are located on the lower side with respect to the display area DA. In planar view, the non-display area NDA1 has a frame width W11 less than the width W1 along the second direction Y. Similarly, the non-display area NDA2 has a frame width W12 less than the frame width W2 along the second direction Y. Therefore, in the bent display device DSP, the frame can be made narrow as compared to the not-yet-bent display device DSP.

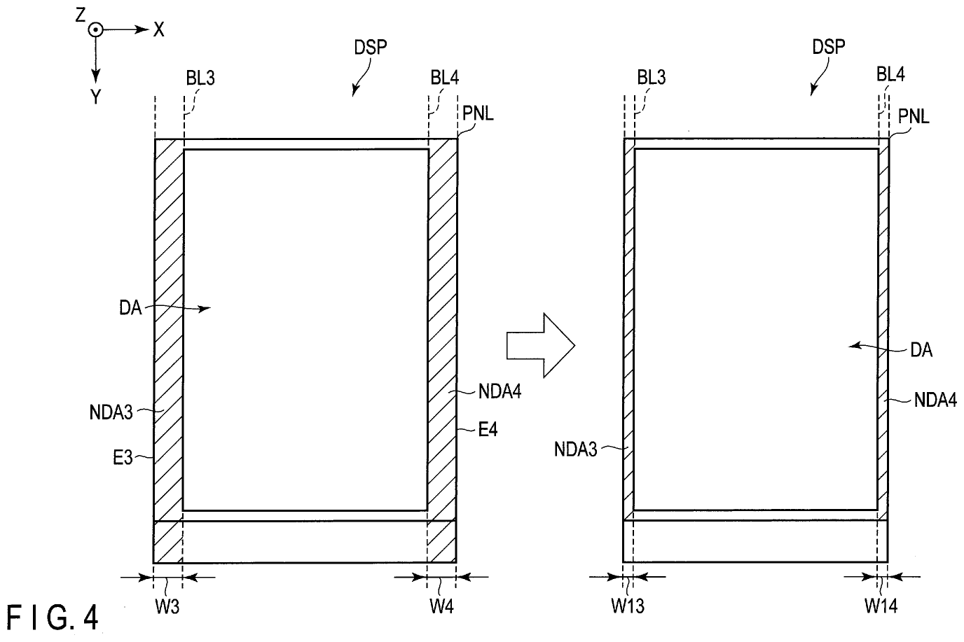

FIG. 4 is an illustration for explaining a state where the display device DSP is bent along the bend lines BL3 and BL4. A plan view on the left side of the drawing shows the display device DSP which is not bent yet. The display device DSP includes non-display areas NDA3 and NDA4 extending along the second direction Y as the non-display area. The non-display area NDA3 is located between the side E3 and the display area DA and has a frame width W3 along the first direction X. The non-display area NDA4 is located between the side E4 and the display area DA and has a frame width W4 along the first direction X.

A plan view on the right side of the drawing shows the display device DSP which is bent along the bend lines BL3 and BL4. The illustrated display device DSP is bent such that the sides E3 and E4 shown in the plan view on the left side are located on the lower side with respect to the display area DA. In planar view, the non-display area NDA3 has a frame width W13 less than the frame width W3 along the first direction X. Similarly, the non-display area NDA4 has a frame width W14 less than the frame width W4 along the first direction X. Therefore, in the bent display device DSP, the frame can be made narrow as compared to the not-yet-bent display device DSP.

Next, the display device DSP bent along any one of the above-described bend lines BL1 to BL4 will be described. As an example, a configuration example where the display device DSP is bent along the bent line BL1 will be described; however, the same applies to the cases of being bent along the other bent lines. Here, it is assumed that the bend line BL1 matches the boundary B1.

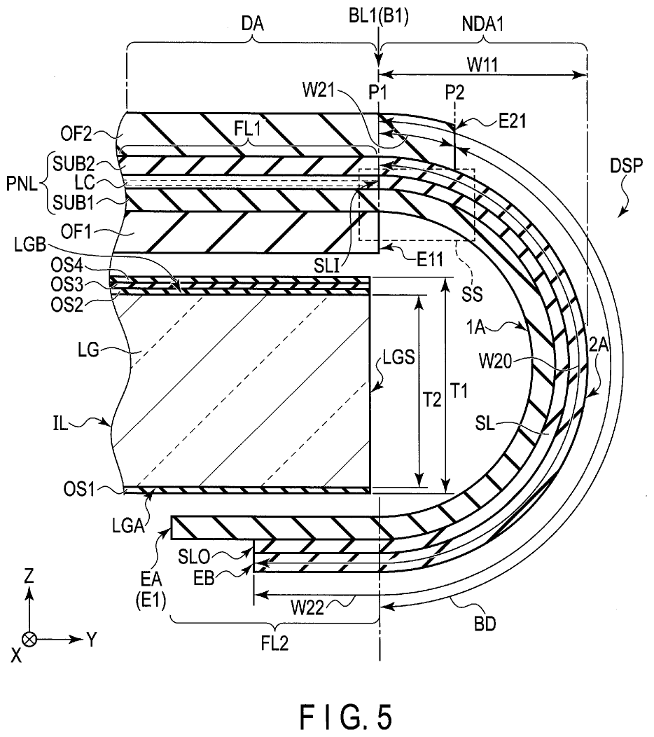

FIG. 5 is a cross-sectional view showing the display device DSP bent along the bend line BL1. The cross-sectional view in the drawing corresponds to a cross-sectional view in a Y-Z plane defined by the second direction Y and the third direction Z. The display panel PNL includes a first flat portion FL1, a bend portion BD and a second flat portion FL2. The bend portion BD is adjacent to the first flat portion FL1, and the second flat portion FL2 is adjacent to the bend portion BD. In the display device DSP bent in the bend portion BD, the first flat portion FL1 and the second flat portion FL2 are opposed to each other in the third direction Z, and the first flat portion FL1 is located on the upper side of the second flat portion FL2. In the second flat portion FL2, the substrate edge EA of the first substrate SUB1 is located farther from the bend portion BD than the substrate edge EB of the second substrate SUB2. In the cross-sectional view in the drawing, the substrate edge EA corresponds to the side E1 shown in FIG. 1.

In the bend portion BD, the first substrate SUB1 is located on the inner circumferential side, and the second substrate SUB2 is located on the outer circumferential side. A lower surface 1A of the first substrate SUB1 corresponds to the inner circumferential surface of the bend portion BD, and an upper surface 2A of the second substrate SUB2 corresponds to the outer circumferential surface of the bend portion BD. The lower surface 1A and the upper surface 2A are curved surfaces, and in the illustrated example, the lower surface 1A and the upper surface 2A are cylindrical surfaces extending in the first direction X. The radius of curvature of the lower surface 1A is less than the radius of curvature of the upper surface 2A.

The sealant SL is filled in the bend portion BD. In the illustrated example, the sealant SL is also filled in the second flat portion FL2. The inner edge SLI of the sealant SL is located in the vicinity of the bend line BL1 or the vicinity of the boundary B1 and is in contact with the liquid crystal layer LC. The inner edge SLI is located in the non-display area NDA1 but is not located in the display area DA beyond the boundary B1. The outer edge SLO of the sealant SL is located in the second flat portion FL2 and overlaps the substrate edge EB. The sealant SL has a total width W20 from the inner edge SLI to the outer edge SLO. Note that the sealant SL may partly contain an airspace. In addition, the sealant SL may be formed of a single material, or the first portion including the outer edge SLO and the second portion including the inner edge SLI may be formed of different materials. For example, the first portion may be formed of a material which has higher waterproofness than that of the second portion, and the second portion may be formed of a material which is less likely to contaminate the liquid crystal layer LC than that of the first portion.

The first optical film OF1 is bonded to the first substrate SUB1 in the first flat portion FL1. The first optical film OF1 is located on the inner circumferential side of the bend portion BD. The first optical film OF1 has a first edge E11 in the vicinity of the bend line BL1 or the vicinity of the boundary B1. The second optical film OF2 is bonded to the second substrate SUB2 in the first flat portion FL1. The second optical film OF2 is located on the outer circumferential side of the bend portion BD. The second optical film OF2 has a second edge E21 in the vicinity of the bend line BL1 or the vicinity of the boundary B1. The first edge E11 is closer to the first flat portion FL1 than the second edge E21. Note that the first optical film OF1 and the second optical film OF2 do not overlap the second flat portion FL2.

In the illustrated example, the first edge E11 does not overlap the bend portion BD, and the second edge E21 overlaps the bend portion BD. In the bend portion BD, a width W21 over which the sealant SL and the second optical film OF2 overlap is less than a width W22 over which the sealant SL and the second optical film OF2 do not overlap. Note that the width W21 is zero in a case where the second edge E21 overlaps the first flat portion FL1 and the second optical film OF2 does not overlap the bend portion BD.

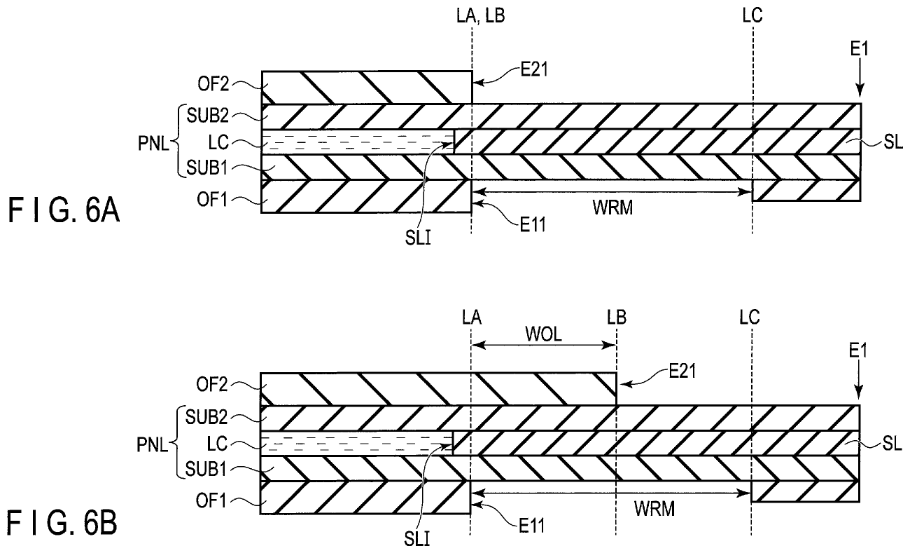

In addition, in the cross-section in the drawing, the first edge E11 of the first optical film OF1 and the second edge E21 of the second optical film OF2 are arranged in this order along the second direction Y, and the inner edge SLI of the sealant SL matches the first edge E11 or is located closer to the display area DA than the first edge E11. When the position of the first edge E11 is referred to as a first position P1 and the position of the second edge E21 is referred to as a second potion P2, in the illustrated example, the inner edge SLI is located at the first position P1. Note that, in a case where the first position P1 is located in the non-display area NDA1, the inner edge SLI may be located between the first position P1 and the boundary B1. Note that the details of the width W21 over which an area where the first optical film OF1 is removed and the second optical film OF2 overlap each other, which is the distance between the first position P1 and the second position P2, will be described later with reference to FIGS. 6A and 6B.

The display panel PNL includes a sealant stopper portion SS in the vicinity of the bend line BL1 or the vicinity of the boundary B1. The sealant stopper portion SS includes a plurality of stoppers which suppress spreading of the sealant SL toward the display area DA at the time of formation of the sealant SL. Although the details of the sealant stopper portion SS will be described later, the stoppers are formed respectively along the sides E1 to E4 in the non-display area NDA shown in FIG. 1. In addition, the stoppers are arranged from the display area DA toward the sides E1 to E4 shown in FIG. 1. The inner edge SLI of the sealant SL overlaps the sealant stopper portion SS.

The illumination device IL is opposed to the first flat portion FL1. In the illustrated example, the illumination device IL is located between the first flat portion FL1 and the second flat portion FL2. In addition, the first optical film OF1 is interposed between the first flat portion FL1 and the illumination device IL.

The illumination device IL includes a light guide LG and a plurality of optical sheets OS1 to OS4. The light guide LG has a lower surface LGA opposed to the second flat portion FL2, an upper surface LGB opposed to the first flat portion FL1, and a side surface LGS opposed to the bend portion BD. The optical sheet OS1 is a reflective sheet and is in contact with the lower surface LGA. The optical sheet OS2 is in contact with the upper surface LGB. The optical sheets OS2 to OS4 are prism sheets, diffusion sheets or the like and are stacked in the third direction Z. The optical sheet OS1 may be in contact with the first substrate SUB1 of the second flat portion FL2. The uppermost optical sheet OS4 may be in contact with the first optical film OF1. The side surface LGS may be in contact with the lower surface 1A of the bend portion BD.

The illumination device IL has a thickness T1 along the third direction Z from the optical sheet OS1 to the uppermost optical sheet OS4. The light guide LG has a thickness T2 along the third direction Z from the lower surface LGA to the upper surface LGB.

The total width W20 of the sealant SL is greater than either of the thickness T1 and the thickness T2. For example, the total width W20 is 1400 μm to 1800 μm, the thickness T1 is 600 μm to 1100 μm, and the thickness T2 is 500 μm to 1000 μm. When the thickness T1 is 600 μm, the sum of the thickness of the first optical film OF1 and the thickness of the first substrate SUB1 is 150 μm, and the sealant SL is formed on the circumference of a semicircle having a radius of, for example, 450 μm, according to calculations, the width of the bend portion BD is 1413 μm, and the total width W20 of the sealant SL is greater than 1400 μm.

When the bend line BL1 matches the boundary B1, the bend portion BD is located in the non-display area NDA1. Since the second optical film OF2 is not bonded to the upper surface 2A, the frame width W11 of the non-display area NDA1 corresponds to the length along the second direction Y between the boundary B1 and the upper surface 2A located farthest from the first flat portion F1. Therefore, the frame width W11 can be reduced as compared to a case where the second optical film OF2 is bonded to the upper surface 2A. In addition, since the first optical film OF1 is not bonded to the lower surface 1A, the lower surface 1A can be brought close to the side surface LGS of the light guide LG. Therefore, the frame width W11 can be reduced as compared to a case where the first optical film OF1 is bonded to the lower surface 1A.

In addition, the first optical film OF1 and the second optical film OF2 which have higher rigidity than the display panel PNL hardly overlap the bend portion BD of the display panel PNL. The first edge E11 of the first optical film OF1 located on the inner circumferential side of the bend portion BD is closer to the first flat portion FL1 than the second edge E21 of the second optical film OF2 located on the outer circumferential side of the bend portion BD. Furthermore, in the bend portion BD, the width W21 over which the sealant SL and the second optical film OF2 overlap is less than the width W22 over which the sealant SL and the second optical film OF2 do not overlap. Therefore, the display panel PNL can be easily bent. Besides, the display panel PNL can be bent to a smaller radius of curvature.

Consequently, the frame can be made narrow in the display device DSP.

Since the sealant SL is filled in the bend portion BD, the first substrate SUB1 and the second substrate SUB2 can be regarded as one elastic body, and buckling of the bend portion BD can be suppressed. In addition, as the frame is made narrow, the bend portion BD is brought close to the display area DA, but non-uniformity of the gap between the first substrate SUB1 and the second substrate SUB2 in the display area DA caused by buckling can be suppressed. Therefore, degradation in display quality can be suppressed.

Furthermore, the display panel PNL includes the sealant stopper portion SS in the vicinity of the bend line BL1 or the vicinity of the boundary B1. Therefore, spreading of the sealant SL toward the display area DA is suppressed, and the position of the inner edge SLI of the sealant SL can be accurately defined.

FIGS. 6A and 6B are schematic cross-sectional views explaining a width WOL over which the second optical film OF2 overlaps with respect to a width WRM over which the first optical film OF1 is removed. In FIGS. 6A and 6B, at the side E1 of the display device DSP shown in FIG. 5, only configurations required for explanations are illustrated and the other configurations are omitted. In addition, a structure before the display device DSP is bent in the bend portion BD is illustrated.

In FIGS. 6A and 6B, a dotted line LA indicates a boundary on the display area DA side of an area in which the first optical film OF1 is removed, and indicates the position of the first edge E11 of the first optical film OF1. In addition, a dotted line LB indicates the position of the second edge E21 of the second optical film OF2, and the width between the dotted line LA and the dotted line LB indicates the width WOL over which the second optical film OF2 overlaps with respect to the width WRM over which the first optical film OF1 is removed. Furthermore, a dotted line LC indicates a boundary on the side E1 side of the display device DSP of the area in which the first optical film OF1 is removed, and to make it easier to understand, a structure in which the first optical film OF1 is left is illustrated in FIGS. 6A and 6B.

FIG. 6A shows a case where the dotted line LA and the dotted line LB overlap, and the width WOL over which the second optical film OF2 overlaps is 0 with respect to the width WRM over which the first optical film OF1 is removed. FIG. 6B shows a case where the dotted line LB is located in the middle between the dotted line LA and the dotted line LC, and the width WOL over which the second optical film OF2 overlaps is half with respect to the width WRM over which the first optical film OF1 is removed. That is, the width WOL over which the second optical film OF2 overlaps with respect to the width WRM over which the first optical film OF1 is removed is preferably 0 to ½.

In FIGS. 6A and 6B, the inner edge SLI of the sealant SL, which is the boundary between the sealant SL and the liquid crystal layer LC, is formed closer to the display area DA than the boundary LA.

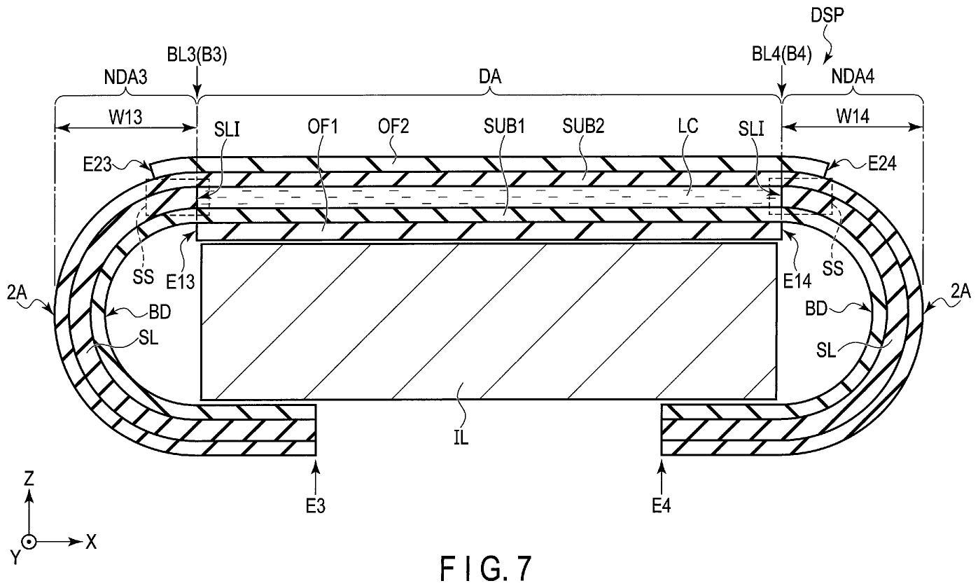

FIG. 7 is a cross-sectional view showing the display device DSP bent along the bend lines BL3 and BL4. The cross-sectional view in the drawing corresponds to a cross-sectional view in an X-Z plane defined by the first direction X and the third direction Z. Here, it is assumed that the bend line BL3 matches the boundary B3 and the bend line BL4 matches the boundary B4.

The sealant SL is filled in the bend portions BD in the non-display areas NDA3 and NDA4. The sealant stopper portions SS are disposed respectively in the vicinities of the bend lines BL3 and BL4. In the vicinity of the bend line BL3, the first optical film OF1 has a first edge E13, and the second optical film OF2 has a second edge E23. The first edge E13 is closer to the display area DA than the second edge E23. Similarly, in the vicinity of the bend line BL4, a first edge E14 of the first optical film OF1 is closer to the display area DA than a second edge E24 of the second optical film OF2.

The frame width W13 of the non-display area NDA3 corresponds to the length along the first direction X between the boundary B3 and the upper surface 2A located farthest from the display area DA. The frame width W14 of the non-display area NDA4 corresponds to the length along the first direction X between the boundary B4 and the upper surface 2A located farthest from the display area DA. As described above, since the display panel PNL can be easily bent in the bend portion BD, the frame widths W13 and W14 can be reduced.

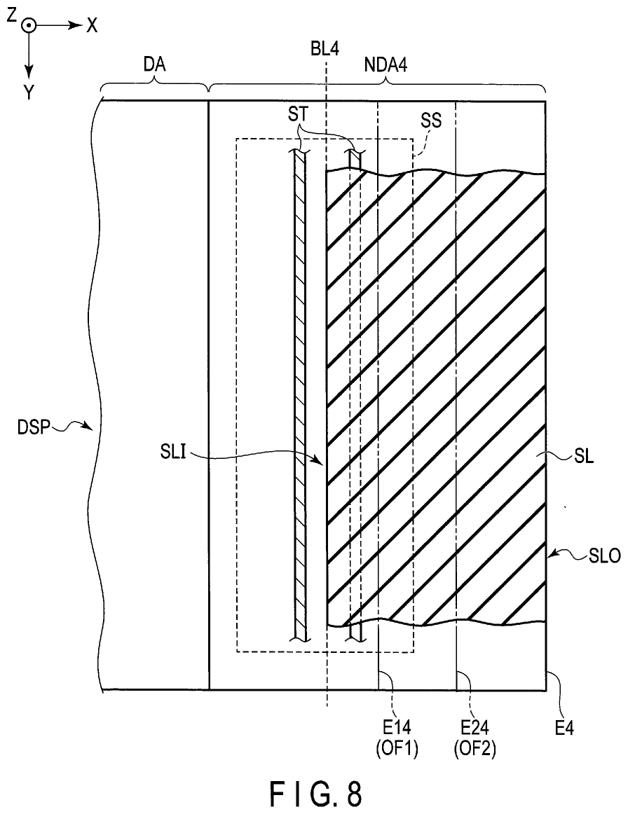

FIG. 8 is a plan view showing a configuration example of the sealant stopper portion SS. Here, the sealant stopper portion SS disposed between the side E4 and the display area DA shown in FIG. 7 will be described. Note that the plan view in the drawing shows the display device DSP which is not bent yet. The sealant stopper portion SS is located away from the side E4 and located close to the display area DA in the non-display area NDA4. The sealant stopper portion SS includes a plurality of stoppers ST. The stoppers ST are at least either of convex portions and concave portions. Each stopper ST extends in the second direction Y. The stoppers ST are arranged at intervals in the first direction X. The stoppers ST are formed to accurately dispose the sealant SL, and are located on the display area DA side and the side E4 side around the bend line BL4 such that the inner edge SLI of the sealant SL matches the bend line BL4.

The sealant SL is filled in the bend portion BD, and as described above, the width of the bend portion BD is increased to greater than or equal to 1400 μm and is significantly increased as compared to a conventional structure, and the amount of the sealant SL is increased, accordingly. As the amount of the sealant SL is increased, due to an error in the amount applied, etc., the inner edge SLI cannot be accurately disposed. For this reason, the stoppers ST are disposed.

When the sealant SL is applied, the sealant SL evenly spreads toward the display area DA and the side E4 around the sealant application point. By disposing the stoppers ST and generating resistance to the movement of the sealant SL, the sealant SL stops at the stopper ST on the display area DA side, and a part of the sealant SL which is to spread toward the display area DA spreads toward the side E4. Even if the position accuracy of the sealant edge of the side E4 side becomes lower than that of the display area DA side, since the side E4 side is the rear surface of the display area DA, the impact on display is small.

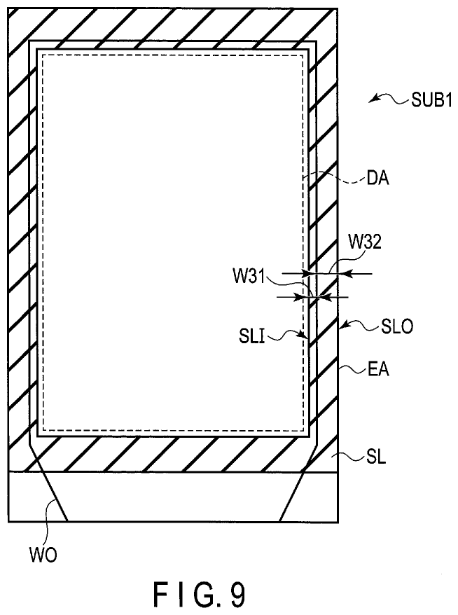

FIG. 9 is a plan view for explaining the positional relationship between the first substrate SUB1 and the sealant SL. The first substrate SUB1 includes an outermost circumferential wiring line OW which is closest to the substrate edge EA. The sealant SL is disposed between the substrate edge EA and the outermost circumferential wiring line WO. The inner edge SLI of the sealant SL is disposed between the display area DA indicated by a dotted line in the drawing and the outermost circumferential wiring line WO. The outer edge SLO of the sealant SL overlaps the substrate edge EA. A width W31 between the inner edge SLI and the outer circumferential wiring line WO is less than a width W32 between the outer circumferential wiring line WO and the outer edge SLO.

Next, more specific configuration examples of the sealant stopper portion SS will be described. Note that, in the following configuration examples, the number of convex portions and the number of concave portions are not limited to the illustrated examples.

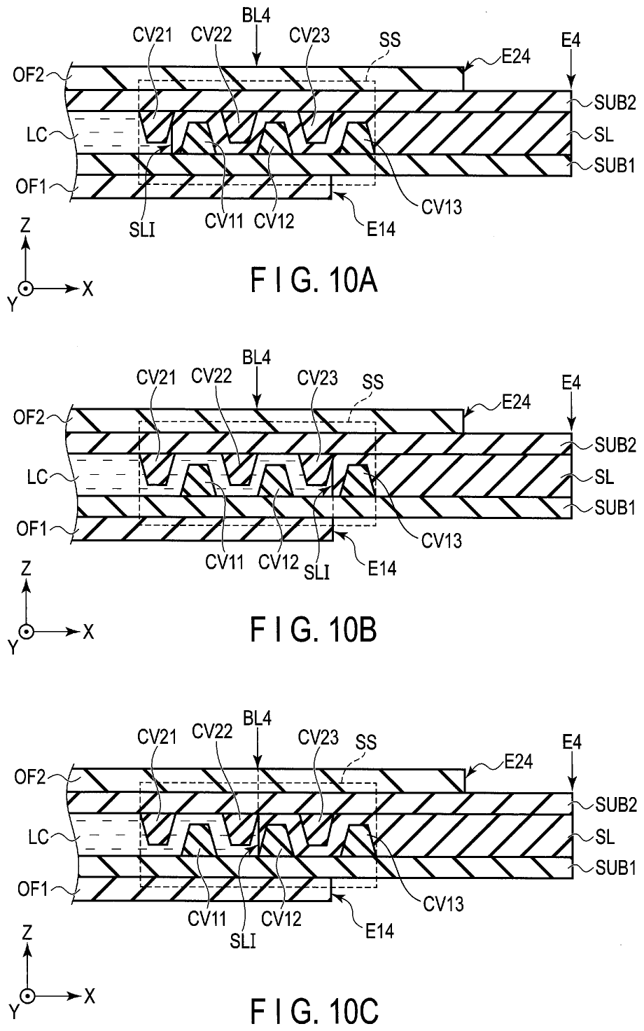

FIGS. 10A to 10C are cross-sectional views showing the first configuration example of the sealant stopper portion SS. The first configuration example corresponds to an example where the sealant stopper portion SS includes a plurality of convex portions as the stoppers. That is, the sealant stopper portion SS includes convex portions CV11 to CV13 and convex portions CV21 to CV23. Note that the convex portions CV11 to CV13 and the convex portions CV21 to CV23 are formed in the shape of a wall along the bend line BL4. The convex portions CV11 to CV13 are arranged in this order at intervals in the first direction X. The convex portions CV21 to VC23 are arranged in this order at intervals in the first direction X. The convex portion CV11 is located between the convex portions CV21 and CV22, the convex portion CV12 is located between the convex portions CV22 and CV23, and the convex portion CV23 is located between the convex portions CV12 and CV13.

The convex portions CV11 to CV13 are disposed in the first substrate SUB1 and project toward the second substrate SUB2. In the illustrated example, the convex portions CV11 to CV13 are separated from the second substrate SUB2 but may be in contact with the second substrate SUB2.

The convex portions CV21 to CV23 are disposed in the second substrate SUB2 and project toward the first substrate SUB1. In the illustrated example, the convex portions CV21 to CV23 are separated from the first substrate SUB1 but may be in contact with the first substrate SUB1. In addition, the convex portions CV21 to CV23 may be in contact with the convex portions CV11 to CV13, respectively.

In the example shown in FIG. 10A, the inner edge SLI of the sealant SL is located on the display area DA side with respect to the position of the bend line BL4. The inner edge SLI is located between the concave portions CV21 and CV11 in the sealant stopper portion SS. The liquid crystal layer LC is interposed between the convex portion CV21 and the first substrate SUB1.

In the example shown in FIG. 10B, the inner edge SLI is located close to the first edge E14 of the first optical film OF1. The inner edge SLI is located between the convex portions CV23 and the CV13 in the sealant stopper portion SS.

The sealant SL is applied such that, even when the sealant SL is formed closest to the side E4, the inner edge SLI overlaps the first edge E14 of the first optical film OF1.

In the example shown in FIG. 10C, the inner edge SLI is formed at the same position as the bend line BL4. The inner edge SLI is located between the convex portions CV22 and CV12 in the sealant stopper portion SS.

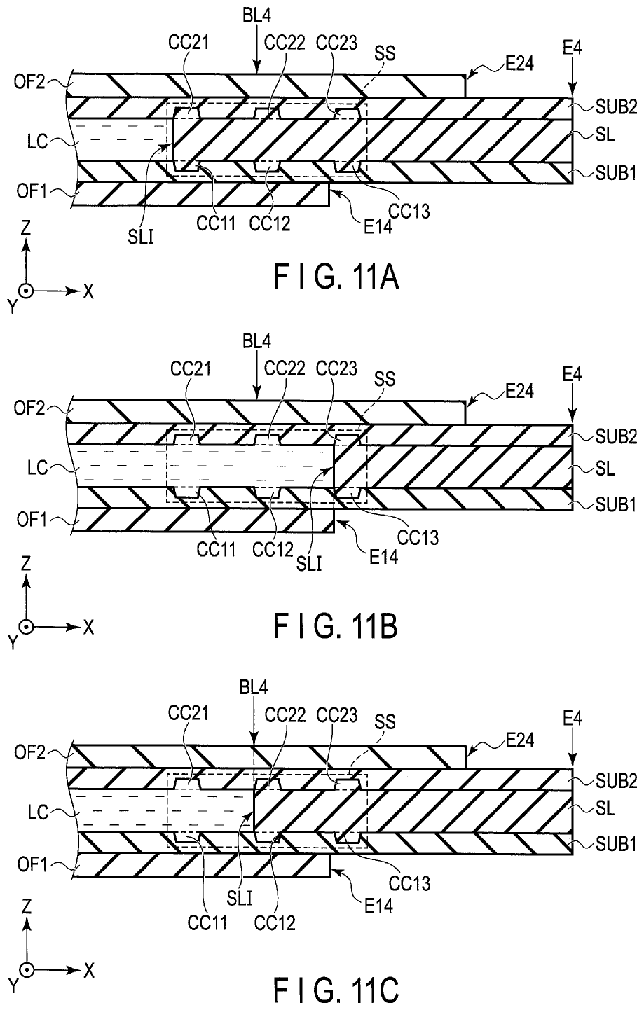

FIGS. 11A to 11C are cross-sectional views showing the second configuration example of the sealant stopper portion SS. The second configuration example corresponds to an example where the sealant stopper portion SS includes a plurality of concave portions as the stoppers. That is, the sealant stopper portion SS includes concave portions CC11 to CC13 and concave portions CC21 to CC23. The concave portions CC11 to CC13 are arranged in this order at intervals in the first direction X. The concave portions CC21 to CC23 are arranged in this order at intervals in the first direction X. The concave portions CC11 to CC13 are disposed in the first substrate SUB1. The concave portions CC21 to CC23 are disposed in the second substrate SUB2.

In the example shown in FIG. 11A, the inner edge SLI is located on the display area DA side with respect to the position of the bend line BL4. The inner edge SLI is located so as to overlap the concave portions CC11 and CC21 in the sealant stopper portion SS.

In the example shown in FIG. 11B, the inner edge SLI is located close to the first edge E14. The inner edge SLI is located so as to overlap the concave portions CC13 and CC23 in the sealant stopper portion SS.

In the example shown in FIG. 11C, the inner edge SLI overlaps the bend line BL4. The inner edge SLI is located so as to overlap the concave portions CC12 and CC22 in the sealant stopper portion SS.

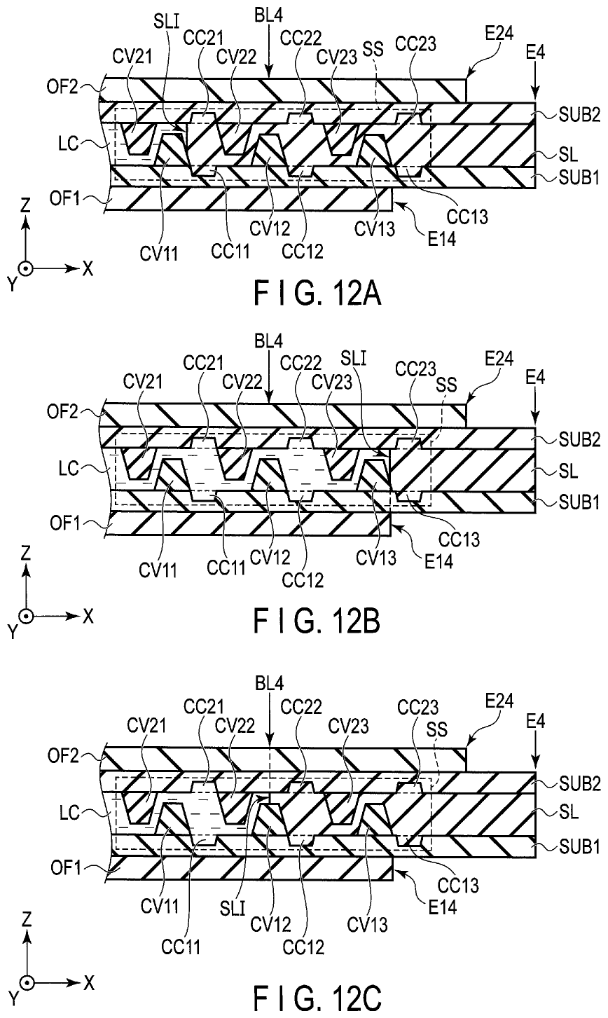

FIGS. 12A to 12C are cross-sectional views showing the third configuration example of the sealant stopper portion SS. The third configuration example corresponds to an example where the sealant stopper portion SS includes both convex portions and concave portions as the stoppers. That is, the sealant stopper portion SS includes the convex portions CV11 to CV13, the convex portions CV21 to CV23, the concave portions CC11 to CC13, and the concave portions CC21 to CC23. The convex portions CV11 to CV13 and the concave portions CC11 to CC13 are disposed in the first substrate SUB1. The convex portions CV21 to CV23 and the concave portions CC21 to CC23 are disposed in the second substrate SUB2.

In the example shown in FIG. 12A, the inner edge SLI is located on the display area DA side with respect to the bend line BL4. The inner edge SLI is located between the convex portion CV11 and the concave portions CC11 and CC21 in the sealant stopper portion SS.

In the example shown in FIG. 12B, the inner edge SLI is located close to the first edge E14. The inner edge SLI is located between the convex portion CV13 and the concave portions CC13 and CC23 in the sealant stopper portion SS.

In the example shown in FIG. 12C, the inner edge SLI overlaps the bend line BL4. The inner edge SLI overlaps the convex portion CV12 in the sealant stopper portion SS.

Next, the liquid crystal display device, which is an example of the display device DSP, will be more specifically described.

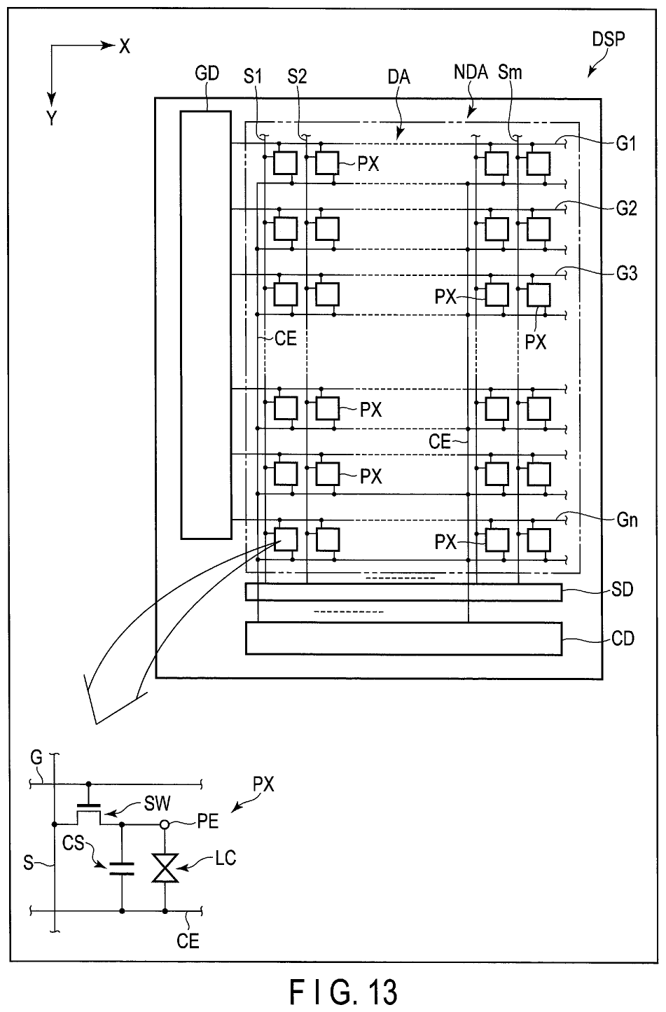

FIG. 13 is an illustration showing the configuration of the display device DSP. The display device DSP includes a plurality of pixels PX, a plurality of scanning lines G (G1 to Gn) a plurality of signal lines S (S1 to Sm) and a common electrode CE in the display area DA. The pixels PX are disposed in a matrix. Each scanning line G extends along the first direction X and is connected to a scanning line driver GD. Each signal line S extends along the second direction Y and is connected to a signal line driver SD. The common electrode CE is disposed over the pixels PX and is connected to a common electrode driver CD.

Each pixel PX includes a switching element SW, a pixel electrode PE, the common electrode CE, the liquid crystal layer LC and the like. The switching element SW is formed of, for example, a thin-film transistor (TFT) and is electrically connected to the scanning line G and the signal line S. The pixel electrode PE is electrically connected to the switching element SW. The pixel electrode PE of each pixel PX is opposed to the common electrode CE. The liquid crystal layer LC is driven by an electric field generated between the pixel electrode PE and the common electrode CE. A storage capacitance CS is formed between, for example, an electrode having the same potential as the common electrode CE and an electrode having the same potential as the pixel electrode PE.

Note that, although detailed descriptions of the configuration of the pixel PX will be omitted here, the pixel PX can employ any one of a display mode using a longitudinal electric field along a normal to a substrate main surface, a display mode using an inclined electric field inclined obliquely with respect to a substrate main surface, a display mode using a lateral electric field along a substrate main surface, and a display mode using an arbitrary combination of the longitudinal electric field, the lateral electric field and the inclined electric field described above. The substrate main surface here is a surface parallel to an X-Y plane defined by the first direction X and the second direction Y.

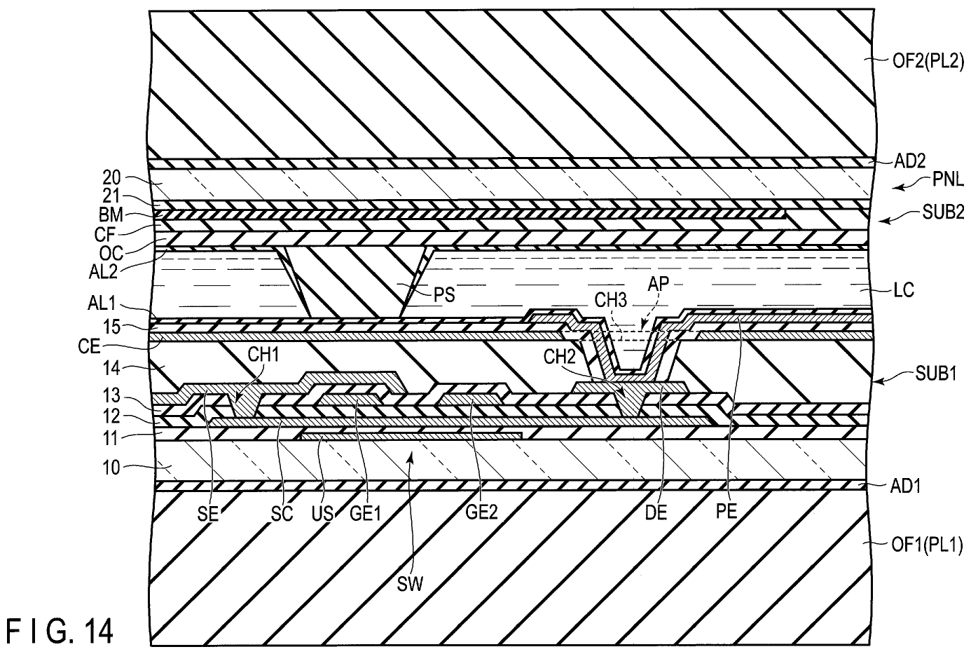

FIG. 14 is a cross-sectional view showing a configuration example of the pixel PX. The illustrated configuration example of the pixel PX corresponds to an example where the display mode using the lateral electric field is applied.

The first substrate SUB1 includes an insulating substrate 10, insulating layers 11 to 15, an underside light-shielding layer US, a semiconductor layer SC, the switching element SW, the common electrode CE, the pixel electrode PE and an alignment film AL1. The insulating substrate 10 is a substrate formed of a resin material such as polyimide and having flexibility and optical transparency. The underside light-shielding layer US is located on the insulating substrate 10 and is covered with the insulating layer 11. The semiconductor layer SC is located on the insulating layer 11 and is covered with the insulating layer 12. The semiconductor layer SC is formed of, for example, polycrystalline silicon but may be formed of amorphous silicon or oxide semiconductor.

In the semiconductor element SW, gate electrodes GE1 and GE2 are located on the insulating layer 12 and are covered with the insulating layer 13. Each of the gate electrodes GE1 and GE2 is electrically connected to any one of the scanning lines G shown in FIG. 13. A source electrode SE and a drain electrode DE are located on the insulating layer 13 and are covered with the insulating layer 14. The source electrode SE is electrically connected to any one of the signal lines S shown in FIG. 13. The source electrode SE is in contact with the semiconductor layer SC via a contact hole CH1 penetrating the insulating layers 12 and 13. The drain electrode DE is in contact with the semiconductor layer SC via a contact hole CH2 penetrating the insulating layers 12 and 13.

The common electrode CE is located on the insulating layer 14 and is covered with the insulating layer 15. The pixel electrode PE is located on the insulating layer 15 and is covered with the alignment film AL1. A part of the pixel electrode PE is opposed to the common electrode CE via the insulating layer 15. The common electrode CE and the pixel electrode PE are formed of a transparent conductive material such as indium tin oxide (ITO) or indium zinc oxide (IZO). The pixel electrode PE is in contact with the drain electrode DE via a contact hole CH3 penetrating the insulating layers 14 and 15 at a position overlapping an aperture AP of the common electrode CE. Note that the insulating layers 11 to 13 and the insulating layer 15 are inorganic insulating layers formed of, for example, silicon oxide, silicon nitride, silicon oxynitride or the like and may have a single-layer structure or a multilayer structure. The insulating layer 14 is an organic insulating layer formed of, for example, acrylic resin or the like.

The second substrate SUB2 includes an insulating substrate 20, an insulating layer 21, a light-shielding layer BM, a color filter layer CF, an overcoat layer OC and an alignment film AL2. The insulating substrate 20 is a substrate formed of a resin material such as polyimide and having flexibility and optical transparency. The insulating layer 21 is located on a side opposed to the first substrate SUB1 of the insulating substrate 20. The insulating layer 21 is an inorganic insulating layer formed of, for example, silicon oxide, silicon nitride, silicon oxynitride or the like, and may have a single-layer structure or a multilayer structure. The light-shielding layer BM and the color filter layer CF are located on a side opposed to the first substrate SUB1 of the insulating layer 21. The light-shielding layer BM can be formed with the light-shielding layer LS shown in FIG. 1 and the like using the same material. The light-shielding layer BM is disposed at positions opposed to the wiring portion of the signal line S, the scanning line G, the switching element SW and the like. The color filter CF is disposed at a position opposed to the pixel electrode PE and partly overlaps the light-shielding layer BM. The overcoat layer OC covers the color filter layer CF. The alignment film AL2 covers the overcoat layer OC.

The gap between the first substrate SUB1 and the second substrate SUB2 is formed by a spacer PS. In the illustrated example, the spacer PS is disposed in the second substrate SUB2 and projects toward the first substrate SUB1. The spacer PS is formed of, for example, an organic insulating material such as acrylic resin.

The liquid crystal layer LC is located between the first substrate SUB1 and the second substrate SUB2 and is held between the alignment film AL1 and the alignment film AL2. The liquid crystal layer LC contains liquid crystal molecules. This liquid crystal layer LC is formed of a positive liquid crystal material (having positive dielectric anisotropy) or a negative liquid crystal material (having negative dielectric anisotropy).

Next, in the display device DSP having the cross-section shown in FIG. 14, specific examples of the convex portions CV and the concave portions CC in the sealant stopper portion SS described above will be described.

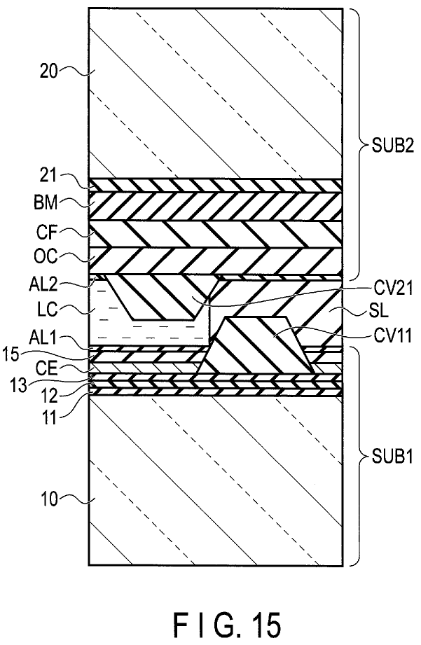

FIG. 15 is an illustration showing a specific example of the convex portions CV11 and CV21. In the first substrate SUB1, the convex portion CV11 is formed of the same material as the insulating layer 14 shown in FIG. 14. That is, the convex portion CV11 is formed on the insulating layer 13 and projects toward the second substrate SUB2. In the second substrate SUB2, the convex portion CV21 is formed of the same material as the spacer PS shown in FIG. 14. That is, the convex portion CV21 is formed below the overcoat layer OC and projects toward the first substrate SUB1. In an area opposed to the convex portion CV21 or a peripheral area of the convex portion CV11, the insulating layer 14 is removed.

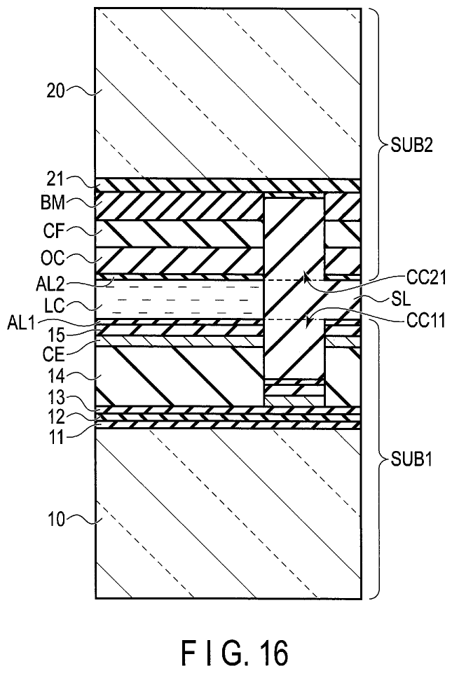

FIG. 16 is an illustration showing a specific example of the concave portions CC11 and CC21. In the first substrate SUB1, the concave portion CC11 is formed by removing the insulating layer 14. In the second substrate SUB2, the concave portion CC21 is formed by removing the light-shielding layer BM, the color filter layer CF and the overcoat layer OC.

As described above, according to the present embodiment, a display device which can make the frame narrow can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Although the liquid crystal display device has been described as an example of the display device in the present embodiment, the display device is not limited to this. The main configurations disclosed in the present embodiment can also be applied to a self-luminous display device including an organic electroluminescent display element or the like, an electronic paper display device including an electrophoretic element or the like, a display device employing micro-electromechanical systems (MEMS), a display device employing electrochromism and the like.

Although the display panel PNL of the present embodiment has been described as a transmissive type which has a transmissive display function of displaying an image by selectively transmitting light from the rear surface side of the first substrate SUB1, the display panel PNL is not limited to this. The display panel PNL may be a reflective type which has a reflective display function of displaying an image by selectively reflecting light from the front surface side of the second substrate SUB2 or a transflective type which has the transmissive display function and the reflective display function. When the display panel PNL is the reflective type, the illumination device IL shown in FIG. 2 will be omitted.

What is claimed is:

1. A display device comprising a display panel comprising a flat portion and a bend portion adjacent to the flat portion, wherein
the display panel comprises:
a first substrate,
a second substrate, and
a sealant which bonds the first substrate and the second substrate together, and
the sealant is filled in the bend portion.

2. The display device of claim 1, further comprising an illumination device opposed to the flat portion, wherein
a width of the sealant is greater than a thickness of the illumination device.

3. The display device of claim 1, further comprising:
a first optical film bonded to the first substrate and having a first edge; and
a second optical film bonded to the second substrate and having a second edge, wherein
the first optical film is located on an inner circumferential side of the bend portion,
the second optical film is located on an outer peripheral side of the bend portion, and
the first edge is closer to the flat portion than the second edge.

4. The display device of claim 3, wherein a width over which the sealant and the second optical film overlap is less than a width over which the sealant and the second optical film do not overlap in the bend portion.

5. The display device of claim 3, wherein the sealant has an inner edge between a first position overlapping the first edge and a second position overlapping the second edge.

6. The display device of claim 1, wherein
the display panel further comprises a sealant stopper portion, and
the sealant has an inner edge overlapping the sealant stopper portion.

7. The display device of claim 6, wherein the sealant stopper portion comprises at least one of a convex portion and a concave portion.

8. The display device of claim 1, wherein
the first substrate has a substrate edge, and
the sealant has an outer edge overlapping the substrate edge.

9. The display device of claim 8, wherein
the first substrate further comprises an outermost circumferential wiring line closest to the substrate edge, and
the sealant is disposed between the substrate edge and the outermost circumferential wiring line.

10. The display device of claim 9, wherein
the sealant has an inner edge located between a display area and the outermost circumferential wiring line, and
a width between the inner edge and the outermost circumferential wiring line is less than a width between the outermost circumferential wiring line and the outer edge.
